(19) United States
(12) Patent Application Publication
(10) Pub. No.: US 2014/0053678 A1
(43) Pub. Date: Feb. 27, 2014

(54) PIVOT LEVER ACTUATION UNIT

(71) Applicants: Reinhard Gottschling, Essen (DE); Markus Schulte, Ennepetal (DE); Sebastian Koch, Wuppertal (DE)

(72) Inventors: Reinhard Gottschling, Essen (DE); Markus Schulte, Ennepetal (DE); Sebastian Koch, Wuppertal (DE)

(21) Appl. No.: 14/009,989

(22) PCT Filed: Feb. 25, 2012
(86) PCT No.: PCT/EP12/00822

§ 371 Date: Nov. 11, 2013

(30) Foreign Application Priority Data
Apr. 6, 2011 (DE) 20 2011 004 951.5

(51) Int. Cl. G05G 1/04

(52) U.S. Cl. CPC G05G 1/04
USPC 74/523

(57) ABSTRACT

A pivot lever actuation unit including an actuating handle which can be folded out of a recess and then swiveled, and an adapter part which can be screwed on under the recess. The actuation unit has a modular construction allowing certain external component parts to be exchanged, and also enables a flexible rebuild.

The present application claims priority from PCT Patent Application No. PCT/EP2012/000822 filed on Feb. 26, 2012, which claims priority from German Patent Application No. DE 20 2011 004 951.5 filed on Apr. 6, 2011, the disclosures of which are incorporated herein by reference in their entirety.

### FIELD OF THE INVENTION

The invention is directed to a pivot lever actuation unit comprising an actuating handle which can be folded out of a recess and then swiveled.

It is noted that citation or identification of any document in this application is not an admission that such document is available as prior art to the present invention.

A pivot lever actuation unit of the general type mentioned above is already known, for example, from DE 20 2006 007 700 U1.

The actuating handle can drive a locking bar via a toothed rack or, when a sash fastener is arranged thereon, can form a sash lock.

It is noted that in this disclosure and particularly in the claims and/or paragraphs, terms such as “comprises”, “comprised”, “comprising” and the like can have the meaning attributed to it in U.S. Patent law; e.g., they can mean “includes”, “included”, “including”, and the like; and that terms such as “consisting essentially of” and “consists essentially of” have the meaning ascribed to them in U.S. Patent law, e.g., they allow for elements not explicitly recited, but exclude elements that are found in the prior art or that affect a basic or novel characteristic of the invention.

It is further noted that the invention does not intend to encompass within the scope of the invention any previously disclosed product, process of making the product or method of using the product, which meets the written description and enablement requirements of the USPTO (35 U.S.C. '112, first paragraph) or the EPO (Article 83 of the EPC), such that applicant(s) reserve the right to disclaim, and hereby disclose a disclaimer of, any previously described product, method of making the product, or process of using the product.

### SUMMARY OF THE INVENTION

it is the object of the invention to further develop the known pivot lever actuation unit and to make it more versatile.

### MODES OF CARRYING OUT THE INVENTION

The above-stated object is met in that the actuation unit has a modular construction allowing certain external component parts to be exchanged, which also enables a flexible rebuild.

Accordingly, the actuation unit can have flap windows with an exchangeable viewing panel at the ends of the recess. The ends of the recess are exchangeable and can be replaced, for example, by a fold-out backlit logo panel.

The ends of the recess may be designed as LCD screen.

Further, the ends of the recess can be designed as exchangeable cover or sleeve for purposes of modular incorporation of additional components such as fingerprint reader, key pad and iris detection.

On the other hand, multi-colored, optionally blinking or non-blinking LEDs can be provided at the ends of the recess.

In particular, the ends of the recess can serve to supply information which shows the state of a quantity of hardware devices.

### BRIEF DESCRIPTION OF THE DRAWINGS

FIG. 1A shows a detailed view of components of a pivot lever actuation unit according to the invention;

FIG. 1B shows another form;

FIG. 2 shows an assembled actuation unit according to FIG. 1A;

FIGS. 3A and 3B show a back side of the actuation unit shown in FIG. 2;

FIG. 4A shows the actuation unit with folded-out hand lever;

FIG. 4B shows the actuation unit according to the invention with folded-out, swiveled hand lever;

FIG. 5A shows a top view of the actuation unit according to FIGS. 4A and 4B with folded-in handle;

FIG. 5B shows an axial section through the arrangement according to FIG. 5A;

FIGS. 6A and 6B show a top view and a sectional view of the pivot lever actuation unit with folded-out lever;

FIGS. 7A and 7B show the same arrangement as in FIGS. 6A and 6B, but with folded-out, swiveled lever;

FIGS. 8A and 8B show an actuation unit with and without cover;

FIG. 9 shows an actuation unit by which a sash fastener or a double bar can be driven;

FIGS. 10 to 12 show various enlarged views of the one (lower) end of the recess.

### DETAILED DESCRIPTION OF EMBODIMENTS

It is to be understood that the figures and descriptions of the present invention have been simplified to illustrate elements that are relevant for a clear understanding of the present invention, while eliminating, for purposes of clarity, many other elements which are conventional in this art. Those of ordinary skill in the art will recognize that other elements are desirable for implementing the present invention. However, because such elements are well known in the art, and because they do not facilitate a better understanding of the present invention, a discussion of such elements is not provided herein.

The present invention will now be described in detail on the basis of exemplary embodiments.

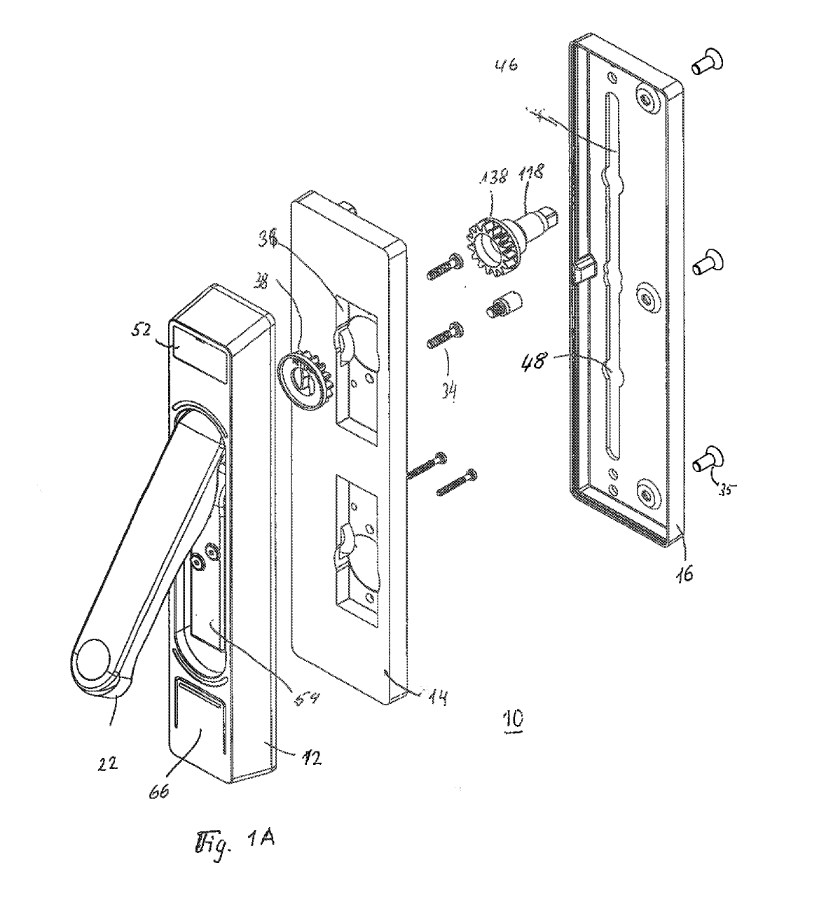

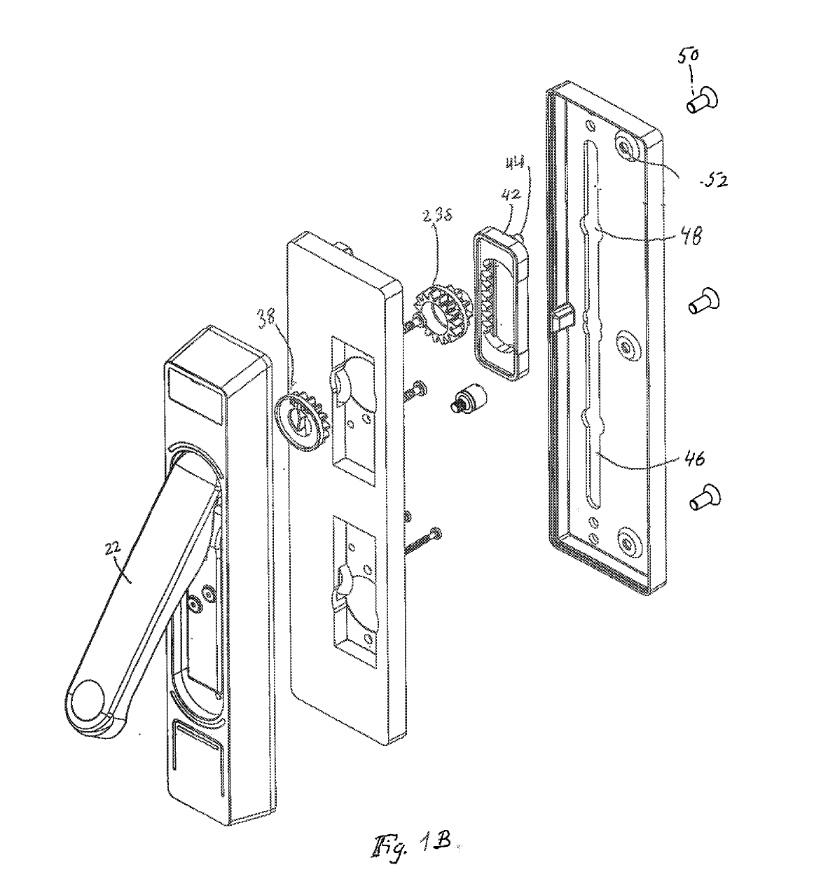

FIG. 1A shows an actuation unit 10 with recess 12, adapter part 14 and base part 16 and a slot 44 therein. A projection 45 of the slide 42 projects through this slot 44 and is used for driving a lock bar. Alternatively, pinion 38 can be coupled with a pinion 138 to drive a shaft 18 which carries a sash fastener tab 28, for example. The shaft 18 or 118 can project through the opening 48.

The two embodiment forms shown in FIGS. 1A and 1B make it possible to drive rotary locks such as sash fasteners (FIG. 1A) and to drive lock bars, i.e., axially displaceable bars for locking and unlocking (FIG. 1B) sash fasteners and bars, not shown.

While FIG. 1A shows an embodiment form having a rotary drive (see pinion 38), FIG. 1B is made for a slot-shaped drive with toothed rack 42.

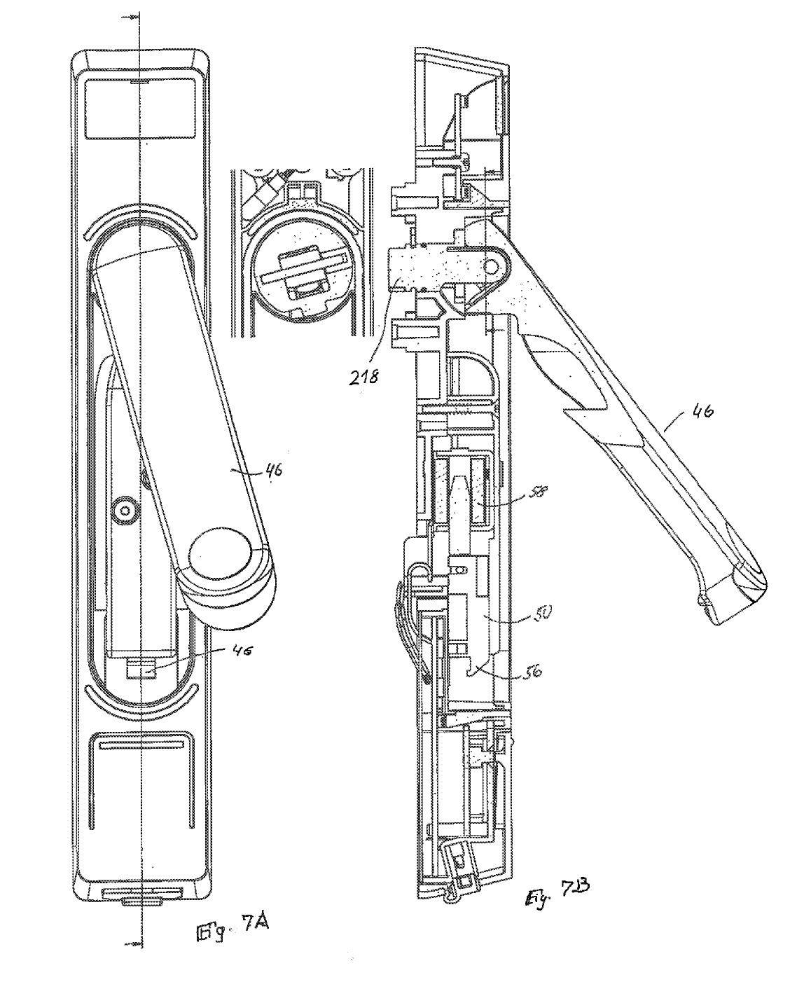

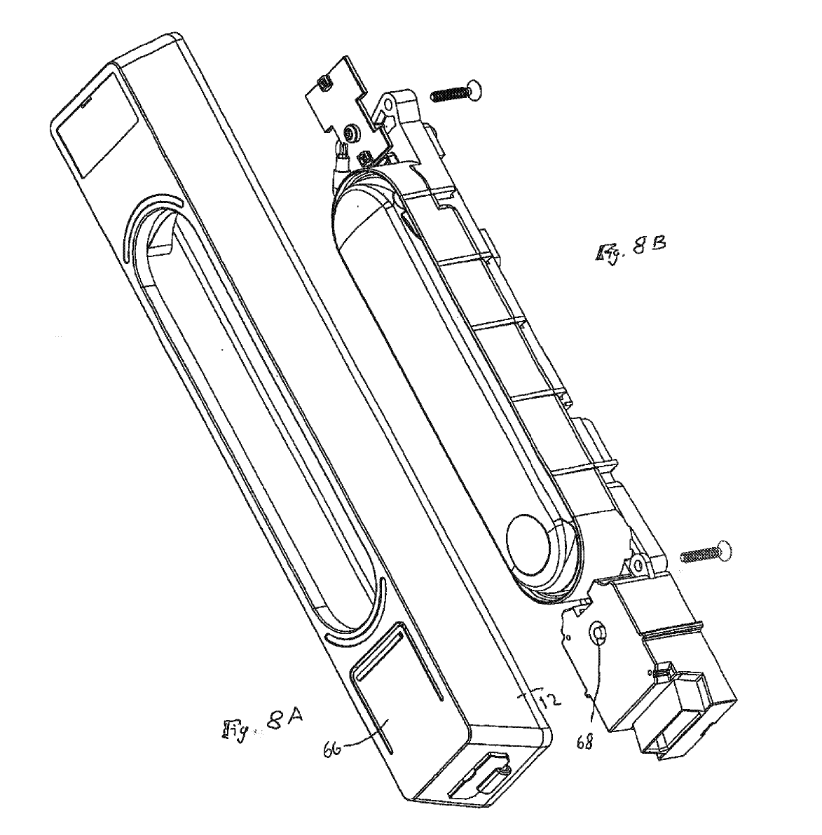

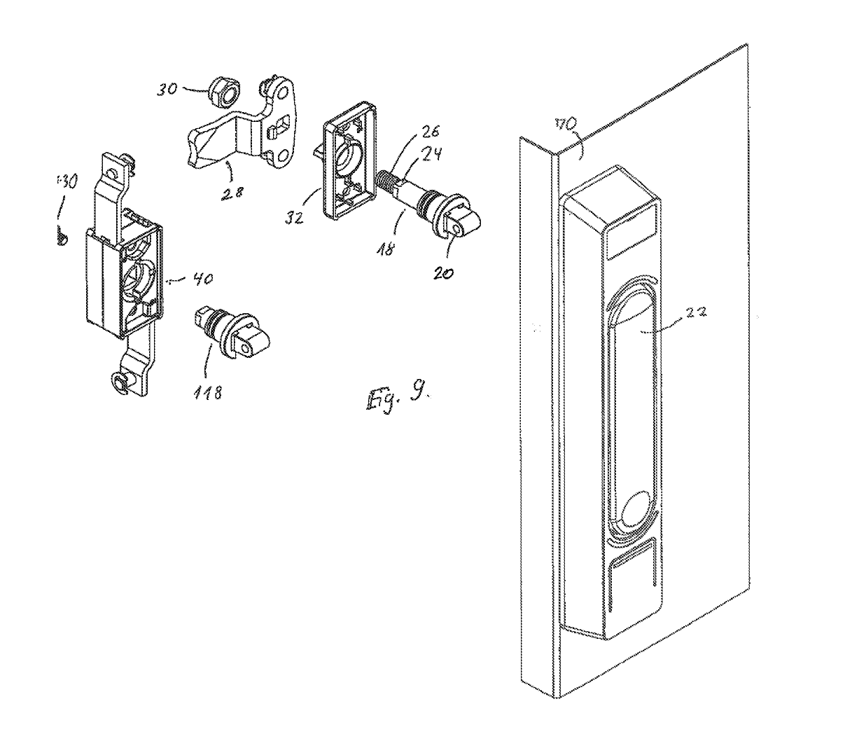

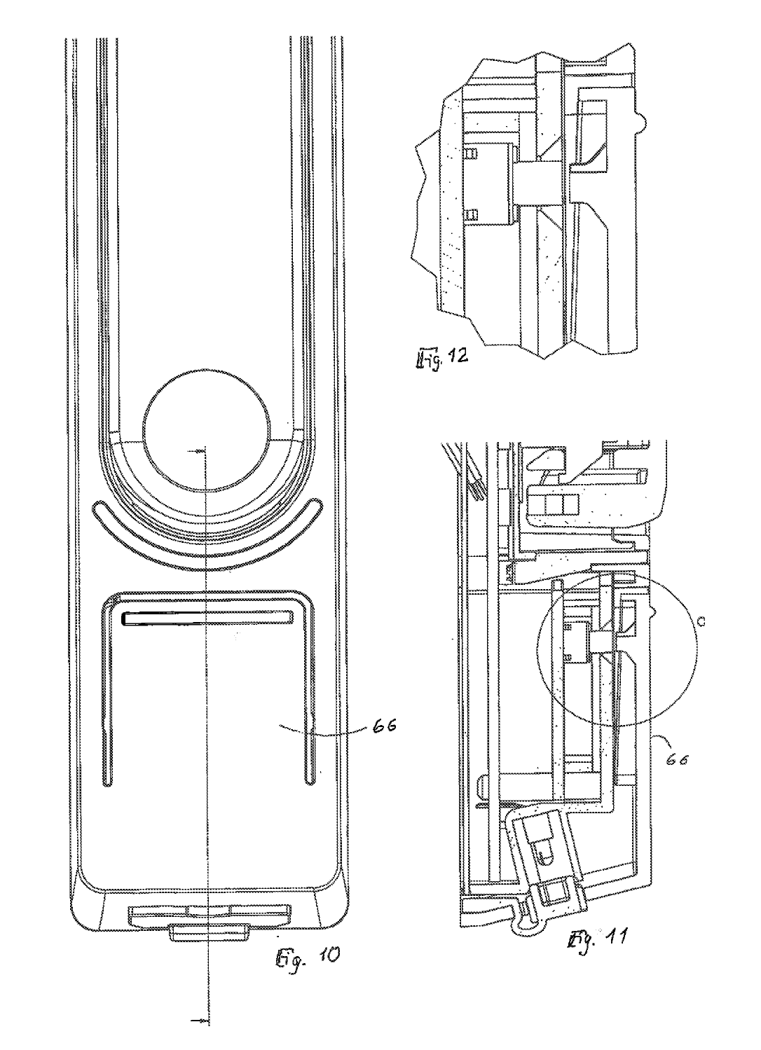

FIGS. 7A and 7B show a lock case, shown in FIG. 9, for bearing support of the drive shaft 218, wherein the pinion 38 is first (FIGS. 1A, 1B) screwed to the recess in the aperture 36 (see FIG. 1A), screws 34 being provided for this purpose. Next, the base part 16 can be screwed on, screws 35 being provided for this purpose.

The embodiment form of the recess shown in FIGS. 1A and 1B is outfitted with a flap 52 with an exchangeable viewing panel. This can also be a backlit logo panel. Alternatively, an LCD screen can be provided behind the window at the ends of the recess.

According to another alternative, the ends of the recess can be designed as exchangeable cover or sleeve for modular incorporation of additional components such as fingerprint reader, key pad or iris detection.

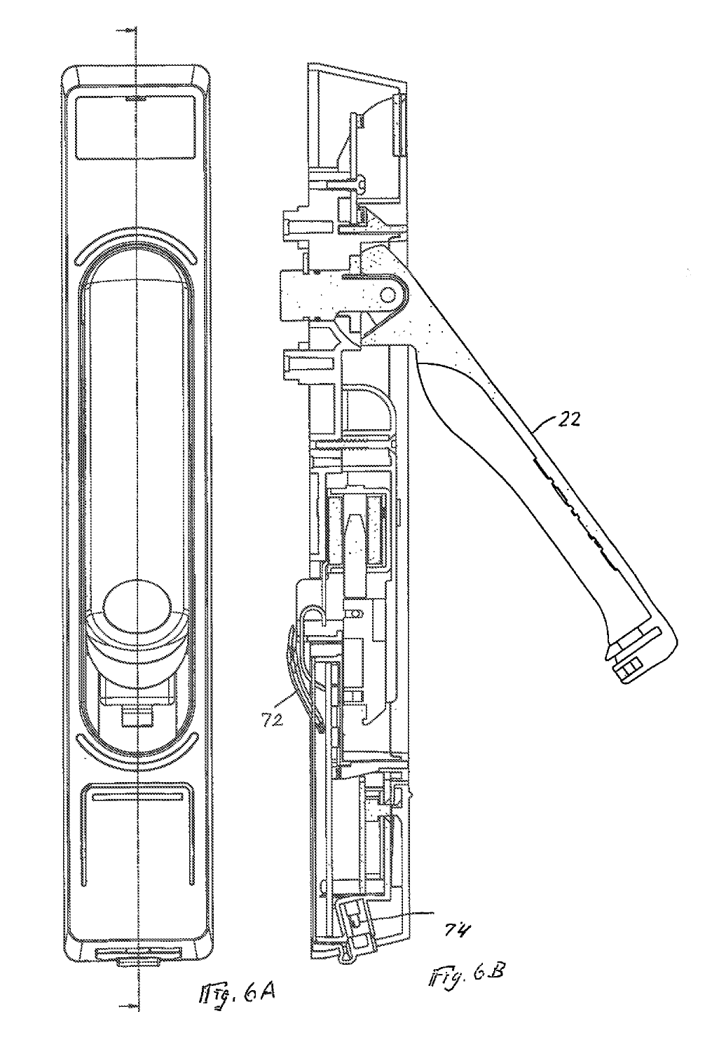

Multi-colored, optionally blinking or non-blinking LEDs can sometimes be provided at the ends of the recess; an LED (light emitting diode) is shown by way of example at 74 in FIG. 6B.

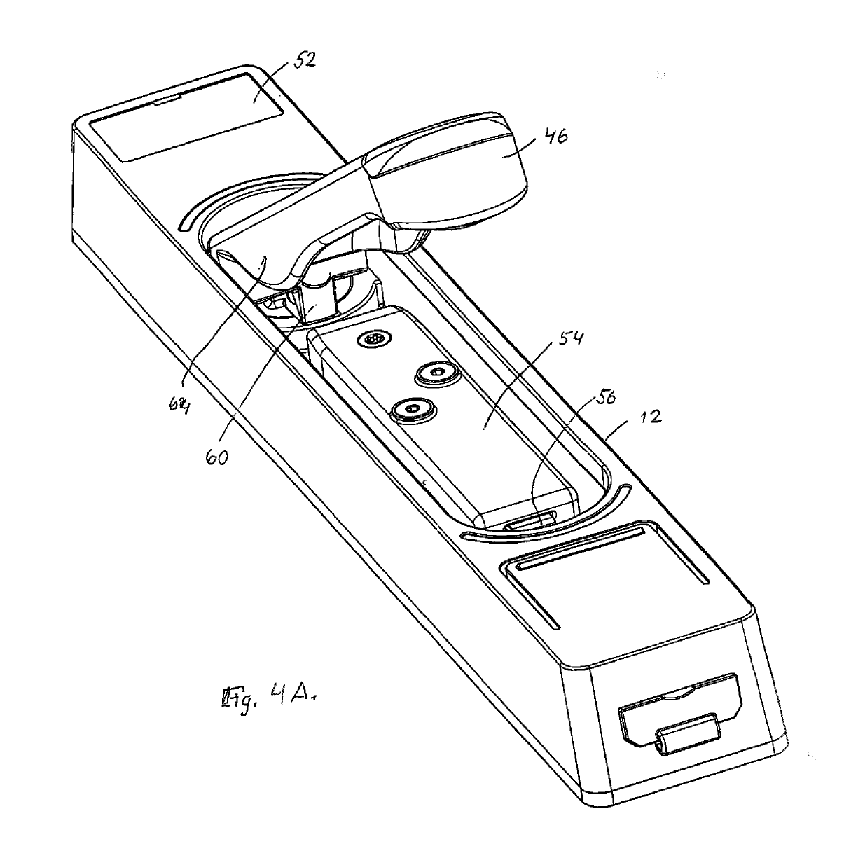

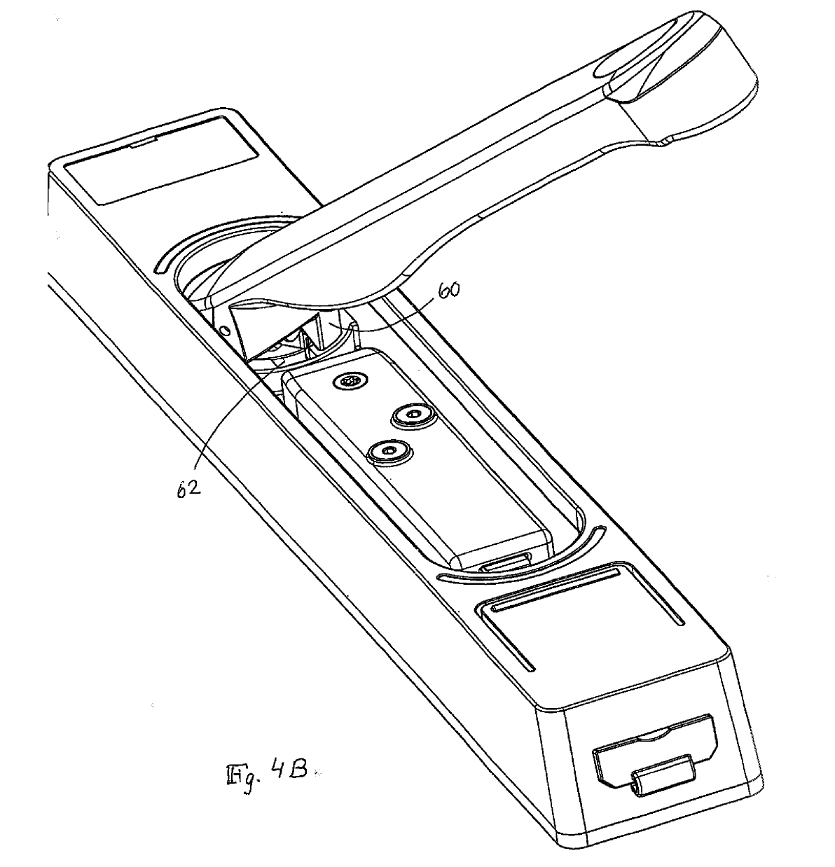

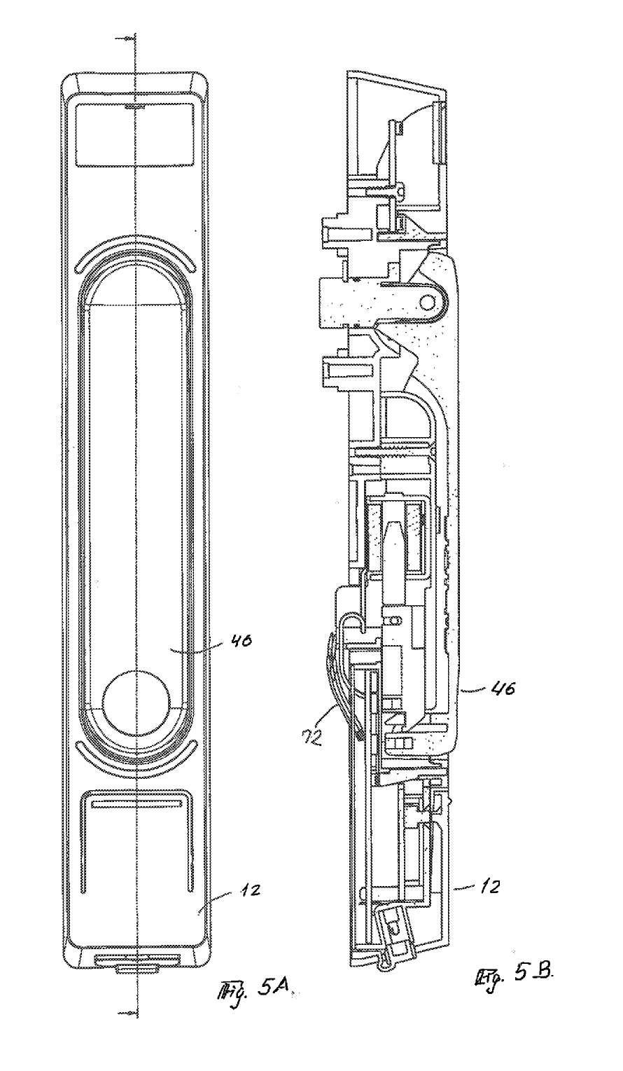

The case 54 which can be seen in FIG. 4A shows an oblique view of the recess part 12 with raised handle 46 which has been released beforehand by a hook 56 (see also FIG. 7B). Component part 50 is part of a slide 50 which can be released by a lift magnet 58. The hand lever 46 is U-shaped in cross section. The legs of the U extend on the left-hand side and right-hand side of a case 54 when the handle 46 is swiveled in. When swiveled in, the hand lever 46 locks automatically by insertion in the component part 50.

As can be seen in FIGS. 4A and 4B, the hand lever 46 can only fold in when it is aligned with respect to the recess 12. This is ensured in that a projection 60 of the hand lever 46 can only penetrate into a corresponding recess surface 62 in this position, but not when it is swiveled out of the fold-in area as in FIG. 4B.

Unauthorized folding out and actuation of the hand lever is also prevented in that the side walls 64 of the hand lever penetrate into the recess and extend between the recess wall and the case wall 54.

The adapter part 14 which can be seen in FIGS. 1A and 1B is symmetrical around its transverse axis and thus allows the recess part to be displaced by 180 degrees, which is useful when changing the fastening arrangement of a switch cabinet door.

The swivel lever is articulated at a shaft 18 as is shown, for example, in FIG. 9. This shaft 18, 118 has at its end a bore hole 20 for fitting the lever 22; a square drive 24 and a screw thread 26 are located at the other end of the shaft 18. Square drive 24 receives a sash fastener 28 fixed by screwing on the nut 30 or a threaded blind hole for head screw 130. Shaft 18 has a bearing portion by which it is supported in a bearing 32 so as to be rotatable but axially fixed. The bearing 32 is in turn provided in a lock case which can be inserted onto an aperture and screwed tight by two screws 34.

Alternatively, a shaft 218 can be provided which cooperates with a lock case which fits exactly into the aperture 36 (see FIG. 9).

Two lock bars (see FIG. 1B and FIG. 9) project out of the lock case, where a pinion 238 meshes with a toothed slide. This toothed slide 42 is guided through projections 44 into a slot.

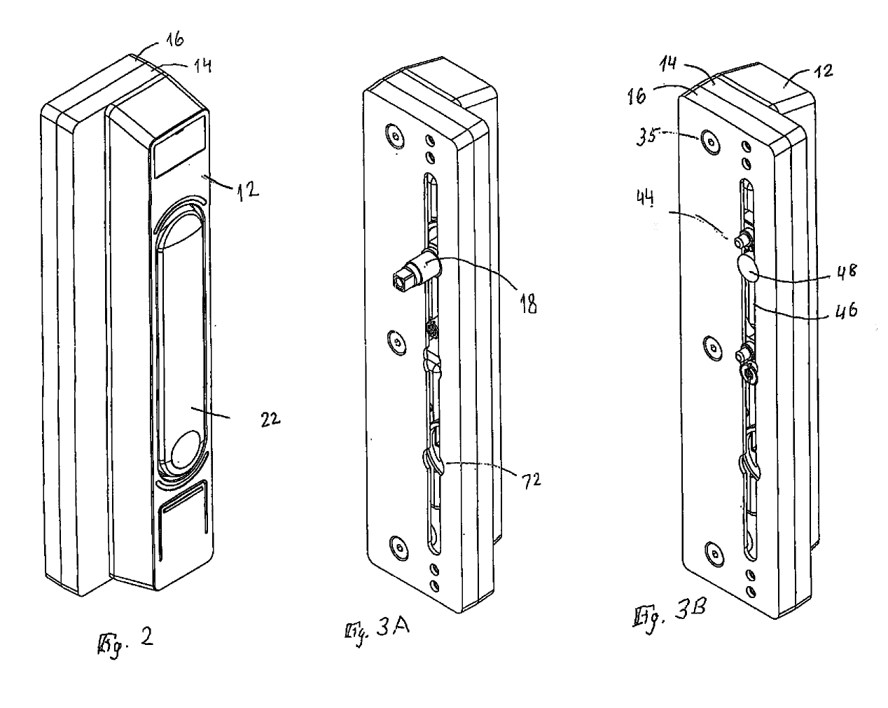

FIG. 2 shows a perspective view of the lever lock according to the invention in the folded-in state, while FIG. 3A shows the same lever lock viewed from the rear, wherein it is arranged in such a way that it can actuate a rotary latch such as a sash latch. This projection 44 is implemented in such a way in the arrangement shown in FIG. 3B that two projecting noses 44 can be seen which drive and displace a locking bar which is located on the other side of the sheet metal wall also having a slot so that this projection 44 can reach through.

The flexibility in the application of the new pivot lever actuation unit also results from the following:

The actuation unit can serve to drive a locking bar located on the door leaf (see the arrangement according to FIG. 4B).

However, locking bar(s) which is (are) arranged upright with respect to the door leaf plane can also be operated by selecting the arrangement in FIG. 9 with the lock case 40.

But a sash fastener can also be operated, e.g., by combining FIG. 9 with the component parts 28, 32 or through the arrangement according to FIG. 3A; the recess is arranged on the door leaf in the first case and on the base plate 16 in the second case.

Versatility is enhanced even further by electronic add-on devices.

### COMMERCIAL APPLICABILITY

The invention is commercially applicable in switch cabinet construction.

While this invention has been described in conjunction with the specific embodiments outlined above, it is evident that many alternatives, modifications, and variations will be apparent to those skilled in the art. Accordingly, the preferred embodiments of the invention as set forth above are intended to be illustrative, not limiting. Various changes may be made without departing from the spirit and scope of the inventions as defined in the following claims.

### LIST OF REFERENCE NUMERALS:

10 pivot lever actuation unit
12 recess part
14 adapter part
16 base part
18, 118 shaft
20 articulation
22 hand lever
24 square drive
26 thread
28 sash fastener
30 nut
32 bearing part
34 screw
36 aperture
38, 138 pinion
40 lock case
42 toothed slide
44 projection
46 slot
48 slot expanded to form a round bore hole
50 slide
52 flap
54 case
56 hook
58 lift magnet
60 projection
62 offset
64 side wall
66 emergency access, button
68 emergency pin
70 door leaf
72 cable
74 LED

1. Pivot lever actuation unit (10) comprising an actuating handle (22) which can be folded out of a recess (12) and then swiveled and an adapter part (14) which can be screwed on under the recess (12), characterized in that the actuation unit (10) has a modular construction allowing certain external component parts to be exchanged and also enables a flexible rebuild.

2. Pivot lever actuation unit according to claim 1, characterized in that the ends of the recess are designed as flap windows (52) with exchangeable viewing panel.

3. Pivot lever actuation unit according to claim 1, characterized in that the ends of the recess are exchangeable.

4. Pivot lever actuation unit according to claim 1, characterized in that the ends of the recess are designed as a fold-out backlit logo panel (52).

5. Pivot lever actuation unit according to claim 1, characterized in that the ends of the recess are designed as LCD screen (52).

6. Pivot lever actuation unit according to claim 1, characterized in that the ends of the recess are designed as exchangeable cover or sleeve for purposes of modular incorporation of additional components such as fingerprint reader, key pad and iris detection.

7. Pivot lever actuation unit according to claim 1, characterized in that multi-colored, optionally blinking and non-blinking LEDs (74) are provided at the ends of the recess.

8. Pivot lever actuation unit according to claim 1, characterized in that the ends of the recess serve to supply information which shows the state of a quantity of hardware devices.
